(19) United States
(12) Patent Application Publication
(10) Pub. No.: US 2008/0162290 A1
(43) Pub. Date: Jul. 3, 2008

(54) Method and apparatus for determining meal status in a restaurant environment

(76) Inventor: Richard Leifer, Melville, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/649,119

(22) Filed: Jan. 3, 2007

(51) Int. Cl. G06Q 50/00

(52) U.S. Cl. 705/15

(57) ABSTRACT

A meal status system and method provides a timing map/list of all activities taking place in a restaurant environment. Timing data is managed, monitored and analyzed to provide, for example, service staff efficiency monitoring, kitchen and bar staff monitoring and generating statistical reports and generated more accurate timing models for establishing a waiting list for tables based on size of parties. A comparison and analysis of all generated data relating to the timing of events taking place in a restaurant environment allows management to easily identify all aspects of the customer service and make determinations on how to increase efficiency and table turn over without degrading the level of customer service demanded by the owner.

### BACKGROUND

1. Field of Technology

The present principles relate to restaurant management systems. More particularly, they relate to a method and system for determining the status of a customer's meal (i.e., how far into their meal they are) and generating more accurate estimates for seating wait times.

2. Description of Related Art

Currently when customers attend a busy restaurant, the host or hostess informs the newly arriving customer that there is a wait for a table. The customer inevitably asks how long the wait will be, and the host replies by providing a guessed time before a table of that size will be available.

The host generally guesses the wait time by observing the available tables and noticing where in the meal the respective customers are. For example, if a table has just been served desert, the host may guess that this table will probably have their desert and pay their check within 20 minutes. The host will then inform the waiting customer that there is a 20 minute wait for a table.

Often times, the host or hostess is not very skilled at making these time estimations based on the meal status of any given customer. In addition, every customer has different dining habits, which significantly affects the ability to accurately determine when they will decide they are finished and obtain their check and leave.

As such, it is desirable to implement an electronic system that maintains the timing for meals status for every table and every customer in the restaurant, and can provide significantly more accurate waiting times using computational processing of based on processed databases of information.

### SUMMARY

According to one aspect of the present principles, the meal status system for restaurants includes a data input device for identifying points in time when a predetermined event occurs, a processor receiving data from the data input device, a plurality of timers maintained by said processor, and a display for displaying any one of said plurality of timers for any of said service locations in the restaurant establishment. In this implementation, each of the plurality of timers correspond to a specific service location

According to another aspect of the present principles, the method for determining meal status in a restaurant environment includes the steps of receiving data input from at least one data input device, logging time entries corresponding to specific events occurring during a meal, and creating a timing list/map for each service location.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a block diagram of the meal status system according to an aspect of the invention;

FIG. 2 is a block diagram of the meal status system according to another aspect of the invention;

FIG. 3 is a diagram showing a plate and a glass fitted with an RFID tag according to an aspect of the invention;

FIG. 4 is a diagram of an RFID tag according to an aspect of the invention;

FIG. 5 is a schematic representation of a restaurant environment implementing the meal status system according to an aspect of the invention; and

FIG. 6 is a flow diagram showing the method for determining meal status in a restaurant environment according to an aspect of the invention.

### DETAILED DESCRIPTION OF PREFERRED EMBODIMENTS

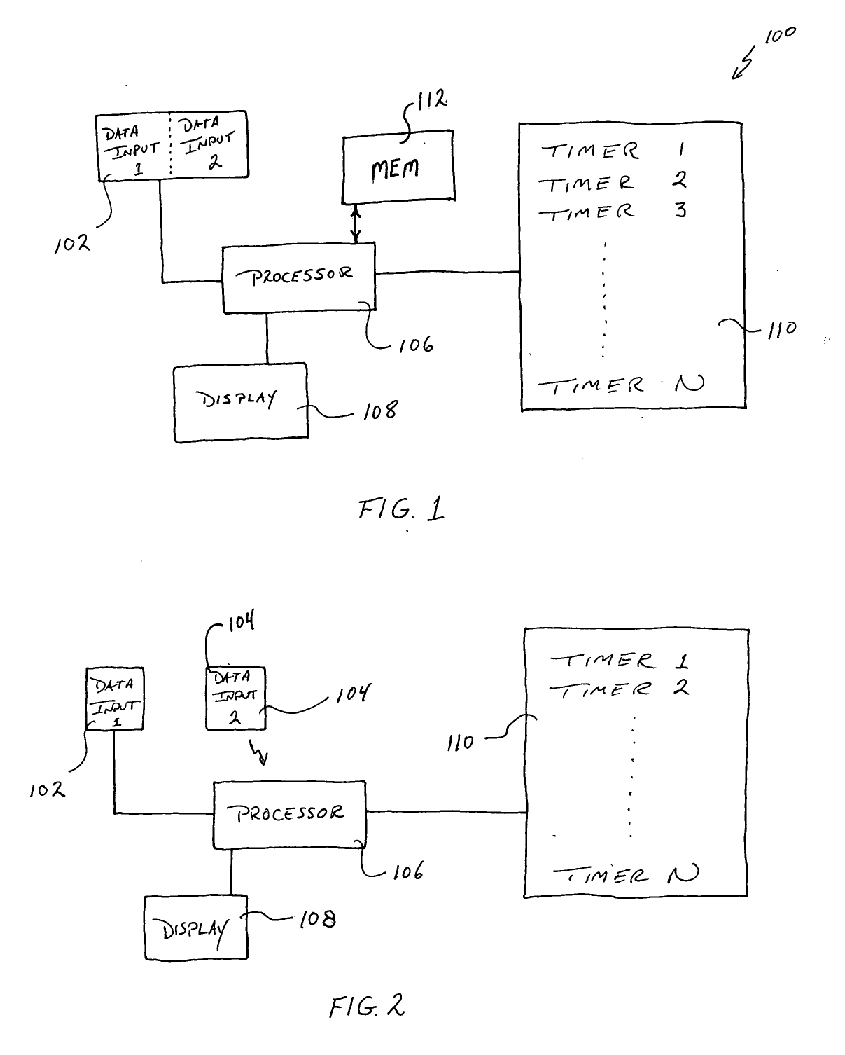

FIG. 1 shows the meal status system 100 according to an aspect of the invention. System 100 includes a processor 106 connected to a display 108, at least one data input device 102 and a timer block 110. A memory device 112 is connected to the processor 106 and can be any suitable type of memory device, for example, a RAM, ROM, disk drive, removable storage device, etc. The timer block 110 represents a plurality of timers 1-N that are maintained throughout the course of a meal.

By way of the following example, the meal status system according on one aspect of the invention is described. Through the use of at least one data input device 102, data is entered into the system relating to the time at which certain events during a meal occur. The following list represents some examples of the types of entries that are made:

An operator, such as, a waiter or host/hostess, can be responsible for the data entry into data input device 102. The form of this data entry (i.e., input device 102) can be through a keyboard, personal digital assistant (PDA) or other input device that can include dedicated buttons or icons set to the desired entries. It is preferred that the data input device is a wireless device 104 to enable freedom of use within the restaurant establishment.

In accordance with one preferred aspect of the invention, each waiter/waitress has their own data input device 104 for their group of tables. Each data input device 104 is in communication with processor 106 which manages the timers 110 and processes the time data. The processing of the time data includes maintaining a timer 1-N for each and every table in the establishment, calculating average times for any one or more combinations of the events (i.e., data entries), providing statistical time calculations for estimating when tables will be freed for the next customer, and providing very accurate indications to management as to the status of each meal at each table in the restaurant establishment.

In an effort to understand the present invention and the concepts described herein, the following shows an example of the types of data entries in a table like form.

TABLE 1

| Event | Time of Event | Total Time Seated |
|---|---|---|
| Table Number or Location | | |
| Seated with Menu | 7:00 p.m. | |
| Seated without Menu | | |
| Menu Provided | | |
| Order Taken | 7:15 p.m. | 15 minutes |
| Drinks served | 7:20 p.m. | 20 minutes |
| Appetizers served | 7:40 p.m. | 40 minutes |
| Main Course served | 8:10 p.m. | 1 hour, 10 minutes |
| Desert Order Taken | 8:45 p.m. | 1 hour, 45 minutes |
| Desert/Coffee served | 9:00 p.m. | 2 hours |
| Check served | 9:15 p.m. | 2 hours, 15 minutes |
| Check paid | 9:20 p.m. | 2 hours, 20 minutes |

As shown in table 1, the time of each event is recorded (via one of the data input means 102, 104) and at the end of a meal, a timing representation of each aspect of the meal can be analyzed.

Another example of the type of data managed in the meal status system of the present invention is shown in TABLE 2.

TABLE 2

| Event | Time of Event | Total Time Seated |
|---|---|---|
| Table Number or Location | | |
| Seated with Menu | 7:00 p.m. | |
| Seated without Menu | | |
| Menu Provided | | |
| Order Taken | 7:15 p.m. | 15 minutes |
| Order submitted to bar/kit. | 7:18 p.m. | 18 minutes |
| Drinks ready at service bar | 7:20 p.m. | 20 minutes |
| Drinks served | 7:25 p.m. | 25 minutes |
| Appetizers ready in Kitchen | 7:30 p.m. | 30 minutes |
| Appetizers served | 7:40 p.m. | 40 minutes |
| Main courses ready in Kit. | 8:00 p.m. | 1 hour |
| Main Course served | 8:10 p.m. | 1 hour, 10 minutes |
| Desert Order Taken | 8:45 p.m. | 1 hour, 45 minutes |
| Desert Order submitted to | 8:48 p.m. | 1 hour, 48 minutes |
| Kit. | | |
| Desert/Coffee ready | 8:55 p.m. | 1 hour, 55 minutes |
| Desert/Coffee served | 9:00 p.m. | 2 hours |
| Check served | 9:15 p.m. | 2 hours, 15 minutes |
| Check paid | 9:20 p.m. | 2 hours, 20 minutes |

As shown in Table 2, not only is the time at which the order is taken at the table entered, the time each order is placed with the kitchen by the waitress/waiter is recorded, in addition to the times at which the orders are ready in the kitchen/service bar, and the times at which the ready orders are served by the waitress/waiter.

By recording the times when the orders are submitted to the kitchen/bar and when the kitchen/bar have filled the orders, in addition to when the waiter/waitress respond to the ready orders, the timing diagram of any particular meal can be easily mapped and analyzed. The data generated by the time mapping of each and every meal that takes place and each and every table in a restaurant can be used, for example, to provide more accurate timing estimation for customer waiting lists and to identify weaknesses/inefficiencies in the kitchen, bar and/or waitress/waiter staff.

As shown in the example of Table 2, one can identify how long it took this particular waiter to respond to the kitchen and/or bar in each instance, and based on other timing maps generated for the same waiter (not shown), a comparison of time can be made to determine whether this server is acting efficiently or not. For example, the appetizers were ready in the kitchen at 7:30, yet the server did not retrieve and serve the appetizers for 10 minutes (i.e. 7:40). By comparing this exemplary time map with this particular server's other time maps for the respective tables, a determination can be easily made as to whether this server was busy during that 10 minute period of time. The efficiency of the wait staff can thus be identified and corrected with a much higher degree of accuracy. This will result in a more pleasurable dining experience for the customers and more efficient turn over of tables for the restaurant establishment.

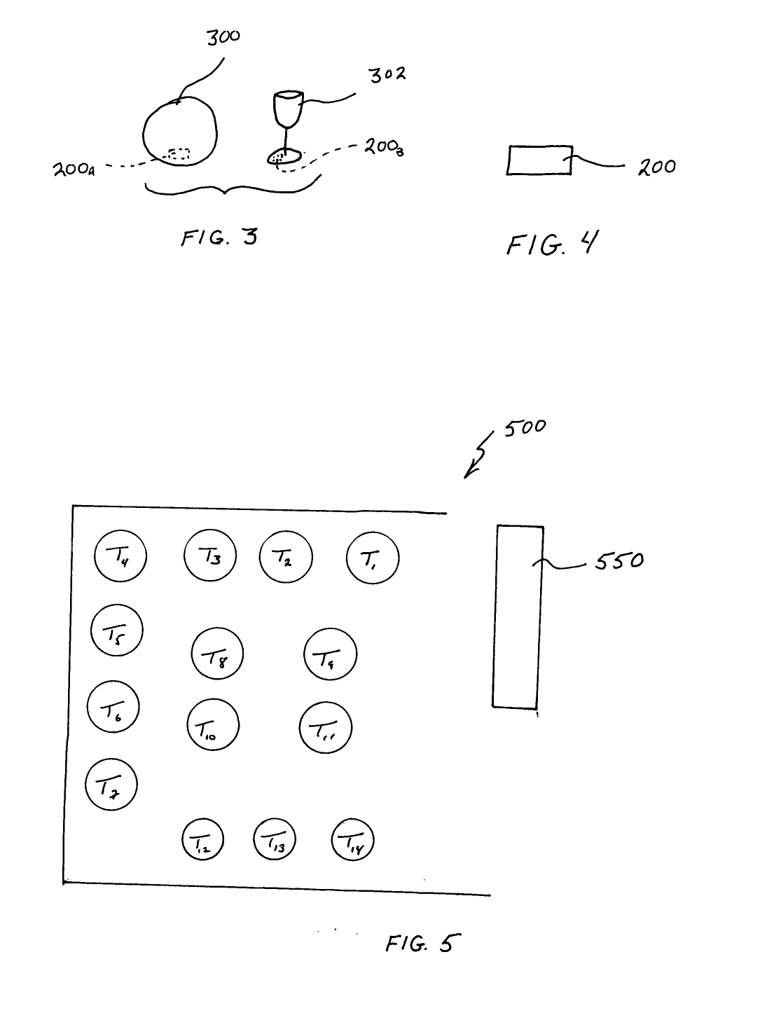

Referring to FIGS. 3 and 4, another form of data input is contemplated that utilizes radio frequency ID tags (RFID) 200. RFID tags are commonly known and are used to uniquely identify a particular object or thing. In the present instance, each plate, glass, utensil, and every other item that is on a table or used to serve customers in a restaurant environment can be uniquely identified with an RFID tag. An RFID tad reading system 550 may be employed throughout the entire restaurant so that at any given moment, the system can determine the location of, for example, a glass from the bar, an appetizer plate, a main course plate, a desert plate, etc. In this manner, the service staff will not be required to input data upon each trip to the table, but rather, each item them bring to the table will be marked with a unique RFID tag allowing the system 550 to identify where everything is in the restaurant, and in particular, what is on each table T1-T15 at any given time.

The system of FIG. 5 shows a restaurant layout 500, where system 550 is not set up to read each RFID tag in the establishment, but rather is designed to read the RFID tag of an item passing under a pre-designated area. For example, the entry and exit to the kitchen and the entry and exit to the service bar area can include these reading systems to allow the RFID tag of each item to be identified and associated with the specific time the tag is identified and read. In accordance with this aspect of the invention, the “time of event” for the serving of the drinks, appetizers, main course, desert/coffee are recorded as the RFID tag passes through the reader, which is presumably only performed when the wait staff has picked up the item(s) and is on their way to the specific table for serving the same. When the same RFID tag is read for a second time, the system will know that this item is being returned to the kitchen or bar area, thus identifying the termination point in time of that event associated with the particular item (e.g., coffee cup, desert plate, etc.). This can minimize the requirement that the service staff make each and every input according to each event at each table.

Thus, in accordance with another aspect of the invention, the display 108 can be situated such that any or the requisite personnel can review the timing map of each table in the establishment. The system provides an easily accessed and significantly more accurate assessment of the status of each and every meal taking place at the restaurant. In addition, the processor 106 can process a program running from memory 112 that enables the system to estimate times for meal completions, and even event completion. In addition, as mentioned previously, statistical programs can be implemented into the system to analyze accumulated data and provide reports on the efficiency of the waiter/waitress staff (e.g., by identifying the time it takes for the waiter/waitress to respond to ready orders, or manage the orders delivered to the tables already), and the kitchen and bar staff (e.g., by analyzing times of orders placed compared to times orders are fulfilled). Other possible implementations of the system of the present invention can include, but are not limited to, monitoring management's ability to handle the restaurant floor and efficient turn tables over and monitoring food and liquor ordering based on food and liquor consumption.

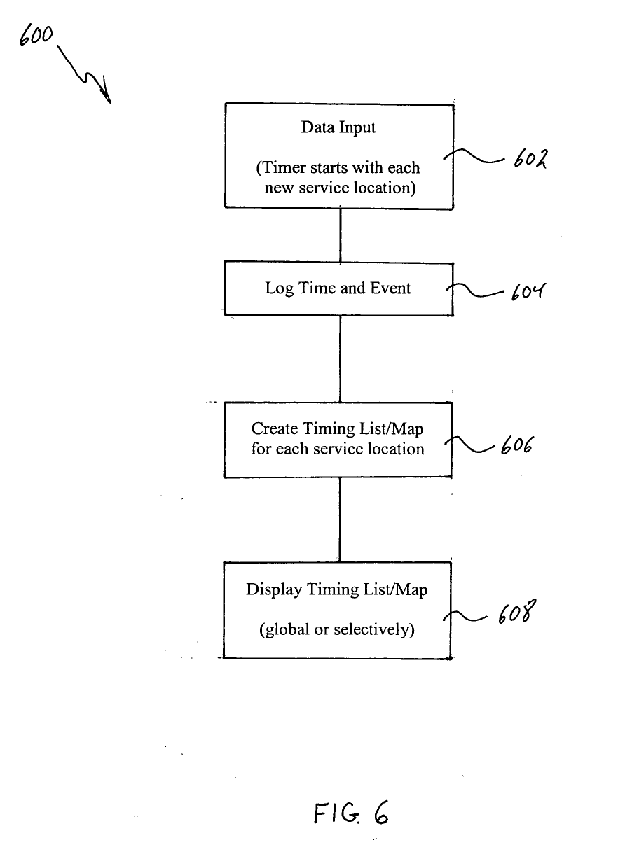

FIG. 6 shows the method 600 according to an aspect of the invention. As shown, the data input 602 is made by any appropriate input device. The initial data input for any given service location (e.g., table) will start the timer for that service location. As the service staff serves that service location, each time and event is logged (604). Once logged, the system creates a timing list/map for each service location (606) and enables the display of the same (608), which allows the management staff to simply identify the status of a meal for any given service location (e.g. table).

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a consumer electronic platform having hardware such as one or more central processing units (CPU) and a random access memory (RAM). The consumer electronic platform also includes an operating system and microinstruction code. The various processes and functions described herein may either be part of the microinstruction code or part of the application program (or a combination thereof) that is executed via the operating system.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

While there have been shown, described and pointed out fundamental novel features of the present principles as applied to preferred embodiments thereof, it will be understood that various omissions, substitutions and changes in the form and details of the methods described and devices illustrated, and in their operation, may be made by those skilled in the art without departing from the spirit of the present principles. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or embodiment of the present principles may be incorporated in any other disclosed, described or suggested form or embodiment as a general matter of design choice. It is the intention, therefore, to be limited only as indicated by the scope of the claims appended hereto.

What is claimed is:

1. A meal status system for restaurants comprising:
data input device for identifying points in time when a predetermined event occurs;
a processor receiving data from the data input device;
a plurality of timers maintained by said processor, each of said plurality of timers corresponding to a specific service location; and
a display for displaying any one of said plurality of timers for any of said service locations in the restaurant establishment.

2. The meal status system according to claim 1, wherein said data input device comprises a keypad located at a designated location in the restaurant.

3. The meal status system according to claim 1, wherein said data input device comprises a wireless computing device carried by restaurant personnel.

4. The meal status system according to claim 1, wherein said specific service location comprises a table.

5. The meal status system according to claim 1, wherein said specific service location comprises a seat at a bar in the restaurant.

6. The meal status system according to claim 1, wherein said predetermined events include at least one selected from a group consisting of service location, seating with menu, seating without menu, menu provides, order taken, drinks served, appetizers served, main course served, desert order taken, desert served, check served and check paid.

7. The meal status system according to claim 1, wherein said predetermined events include at least one selected from a group consisting of service location, seating with menu, seating without menu, menu provided, order taken, order submitted to bar/kitchen, drinks server, appetizers ready in kitchen, appetizers served, main courses ready in kitchen, main course served, desert order taken, desert order submitted to kitchen, desert order ready in kitchen, desert served, check served and check paid.

8. The meal status system according to claim 1, wherein each timer maintains a timing list for each of the plurality of predetermined events occurring at each service location.

9. The meal status system according to claim 6, wherein each timer maintains a timing list for each of the plurality of predetermined events occurring at each service location.

10. The meal status system according to claim 7, wherein each timer maintains a timing list for each of the plurality of predetermined events occurring at each service location.

11. The meal status system according to claim 1, wherein said data input device comprises an RFID tag on every object used to serve customers in the restaurant.

12. The meal status system according to claim 11, further comprising an RFID tag reading system connected to said processor and adapted to read an RFID tag anywhere within the restaurant environment.

13. The meal status system according to claim 11, further comprising an RFID tag reading system connected to said processor and disposed at an entry/exit of a kitchen.

14. The meal status system according to claim 11, further comprising an RFID tag reading system connected to said processor and disposed at an enrty/exit of a service bar for the restaurant environment.

15. A method for determining meal status in a restaurant environment comprising the steps of:
receiving data input from at least one data input device;
logging time entries corresponding to specific events occurring during a meal; and
creating a timing list/map for each service location.

16. The method according to claim 15, wherein said step of receiving data is performed by a wireless data input device.

17. The method according to claim 15, further comprising displaying the created timing list/map for each service location.

18. The method according to claim 15, further comprising displaying the created timing list/map for all service locations in a global display.

19. The method according to claim 15, wherein said step of receiving data is performed by service staff in the restaurant.

20. The method according to claim 15, wherein said step of receiving data is performed by RFID tags on every object used to serve customers in the restaurant.
